(19) United States
(12) Patent Application Publication
(10) Pub. No.: US 2006/0190674 A1
(43) Pub. Date: Aug. 24, 2006

(54) Hub chip for connecting one or more memory chips

(76) Inventor: Peter Poechmueller, Dresden (DE)

Correspondence Address: PATTERSON & SHERIDAN, LLP;Gero McClellan / Infineon Technologies, 3040 POST OAK BLVD.,, SUITE 1500, HOUSTON, TX, 77056, US

(21) Appl. No.: 11/348,297

(22) Filed: Feb. 6, 2006

Related U.S. Application Data
(63) Continuation of application No. PCT/EP04/08783, filed on Aug. 5, 2004.

(30) Foreign Application Priority Data
Aug. 6, 2003 (DE) DE 103 35 978.8

(51) Int. Cl. G06F 12/14

(52) U.S. Cl. 711/103

(57) ABSTRACT

The invention relates to a hub chip for connecting one or more memory chips via a respective memory chip interface, having an address input for connecting the hub chip to an address bus and having an address output for connection to a further address bus, having an address decoder unit configured to use an address applied to the address input to address one of the connected memory chips or to apply the applied address to the address output, characterized by an error recognition unit configured to use provided checking data to detect an error in a memory area of the one or more memory chips.

### CROSS-REFERENCE TO RELATED APPLICATIONS

This application is a continuation of co-pending PCT patent application No. PCT/EP 2004/008783, filed Aug. 5, 2004, which claims the benefit of German patent application serial number DE 103 35 978.8, filed Aug. 6, 2003. Each of the aforementioned related patent applications is herein incorporated by reference in its entirety.

### BACKGROUND OF THE INVENTION

1. Field of the Invention

The invention relates to a hub chip for connecting one or more memory chips in a memory system.

2. Description of the Related Art

Memory chips are frequently used in personal computers in order to store data for processing in the personal computer. The memory chips are usually combined to form memory modules in order to increase the storage capacity. To use the storage capacity of a plurality of memory modules, an address and data bus is usually provided which has the memory modules connected to it in parallel, i.e., each of the memory modules is connected to the joint address and data bus. On account of the line and input capacitances of the relevant inputs for the address and data bus on the memory modules and also reflection of the signals at branch points, the maximum clock frequency which can be used to transmit address data and useful data is limited.

Particularly when Double Data Rate (DDR) technology is used, the frequencies at which data are transmitted via the address and data bus can be very high. For future DDR-III or other high-performance interface technologies, it is therefore appropriate not to operate the memory modules on a joint address and data bus.

One possible alternative address and data bus concept involves providing a “hub chip” between a memory controller in the personal computer and the memory chips, which is used to actuate one or more memory chips. The hub chip is connected to the memory controller, which controls the storage and retrieval of data. The hub chip has an input for the address and data bus in order to receive address data and useful data and to transmit any useful data to the memory controller. The hub chip also has an output which is used to output address and useful data. The output for the address and useful data can be connected to an input of a further downstream hub chip, which in turn has memory chips connected to it.

The hub chip has an address decoder unit which receives the applied address and, depending on the address, either addresses one of the connected memory chips or applies the applied address to the address output, so that it can be forwarded to the next hub chip.

Memory chips cannot be produced without errors on account of the production technology. Errors which occur are repaired in several steps, both in a front-end repair step and possibly in a back-end repair step. Nevertheless, the memory chips repaired in this way may have further errors, sometimes even just under particular conditions (e.g., chip degradation during operation). These errors can result in the computer system no longer operating in a stable fashion or errors occurring during the execution of a piece of software.

### SUMMARY OF THE INVENTION

It is an object of the present invention to provide a hub chip which provides a greater level of reliability during operation in a computer system and provides greater transparency about errors which have occurred.

The invention provides a hub chip for connecting one or more memory chips via a respective memory chip interface. The hub chip has an address input for connecting the hub chip to an address bus and an address output for connection to a further address bus. The hub chip also has an address decoder unit so as to use an address applied to the address input to address one of the connected memory chips or to apply the applied address to the address output. The hub chip has an error recognition unit configured to utilize provided checking data to detect an error in the memory area of the one or more memory chips.

The inventive hub chip has the advantage that it has an error recognition unit which allows an error which occurs in one of the connected memory chips to be detected. This is done using checking data which are made available to the error recognition unit. The errors recognized can be used to inform the computer system in which the hub chip is preferably being used about the error which has occurred or to repair the error using the checking data. Provision may be made for the hub chip to have a further memory chip interface utilized to receive the checking data, e.g., from a further memory chip, in order to check the contents of the memory areas of the connected memory chips. In this way, the checking data can easily be made available to the hub chip.

The address decoder unit may be designed to store or read useful data in a first portion of the memory areas of the connected memory areas of the chips and to store or read the checking data in a second portion of the memory areas, said checking data being able to be used to check the contents of the memory areas of the connected memory chips using the error recognition unit. As a result, it is possible to avoid providing the further memory chip interface and the further memory chip connected thereto and instead to cover the additional memory requirement for the checking data using the connected memory chips.

Provision may also be made for the error recognition unit to check the correct storage of the useful data using an error recognition method, particularly using a parity check method.

Provision may also be made for the error recognition unit to have an error correction unit so as to correct erroneous useful data on the basis of the checking data, particularly using a Humming code method. The error correction unit allows for errors which occur in the connected memory chips to be corrected using the additionally provided checking data (correction data), so that fault-free operation of the computer system remains assured.

In addition, an error register may be provided in the hub chip so as to store error information about the number of errors which have occurred, the type of errors which have occurred and/or the addresses of the errors which have occurred. The error information can be read from the error register in the hub chip. This allows the user of memory modules, which are made up of hub chips and memory chips, to recognize and to check the quality of the memory chips used.

In line with a further aspect of the present invention, a memory module having a hub chip and having one or more memory chips connected to the hub chip is provided.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a block diagram of a memory system having memory modules with inventive hub chips based on a first embodiment of the invention; and

FIG. 2 shows a memory system having memory modules with inventive hub chips based on a second embodiment.

### DETAILED DESCRIPTION OF THE PREFERRED EMBODIMENT

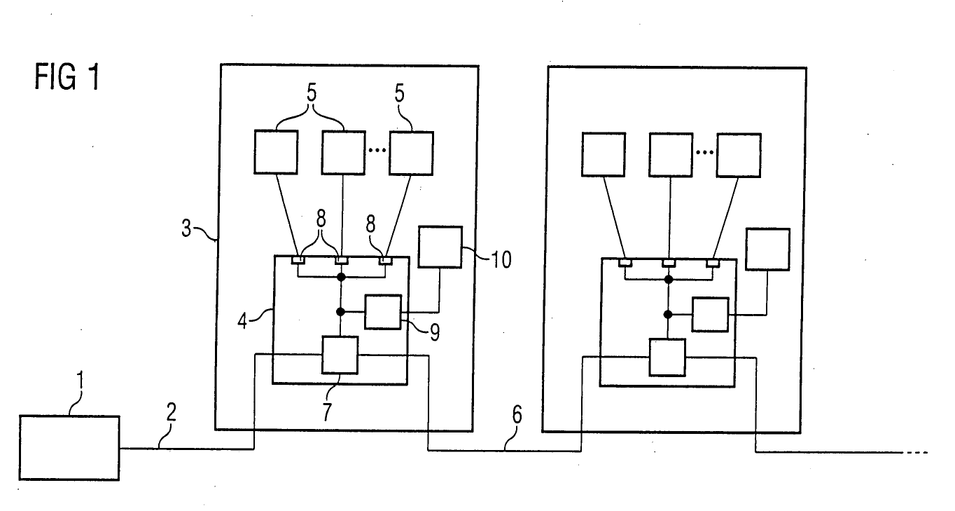

FIG. 1 shows a memory system, e.g., for a computer system, particularly a DDR memory system. The memory system has a memory controller 1 to which an address bus 2 with a number n of address lines is connected. The address lines are connected to an input of a memory module 3. The memory module 3 has a hub chip 4 to which one or more memory chips 5, e.g., DRAM memory chips, are connected. The number of connected memory chips 5 is determined by the address space which is to be formed. The address input of the memory module 3 is connected to an address input of the hub chip 4. The hub chip 4 has an address output which is connected to a further address bus 6 via the address output of the memory module 3. The further address bus 6 is connected to an address input of a further memory module.

The hub chip 4 has an address decoder unit 7 which checks the addresses which are present on the address bus 2 and, depending on the address applied, addresses the relevant connected memory chip 5 via a respective memory chip interface 8 or forwards the applied address to the further address bus 6. The address decoder unit in the hub chip of the next memory module then receives the address from the further address bus 6 and, in the same way, either uses it to address one of the memory chips connected there or forwards it to another further address bus via the address output.

Instead of providing an individual memory chip interface 8 for each of the connected memory chips 5, a joint memory chip interface 8 may also be provided which is connected to all of the connected memory chips 5 via an address and data bus inside the memory module. Separate memory chip interfaces 8 have the advantage that the memory chips 5 can be addressed essentially in parallel or at higher speed under the control of the HUB chip, whereas a memory chip interface of joint design allows the wiring complexity of the memory module 3 to be reduced.

The hub chip 4 also has an error recognition unit 9 which, when data are stored and/or read from the connected memory chips 5, uses known error recognition algorithms to check the data on the basis of provided checking data and can detect an error when data are stored erroneously. The error can be sent to the memory controller via the address bus or via a data bus running parallel to the address bus, in order to report to the computer system that an error has occurred during storage or retrieval of a data item.

The checking data can be provided by a further memory chip 10, for example, which is likewise provided on the memory module 3.

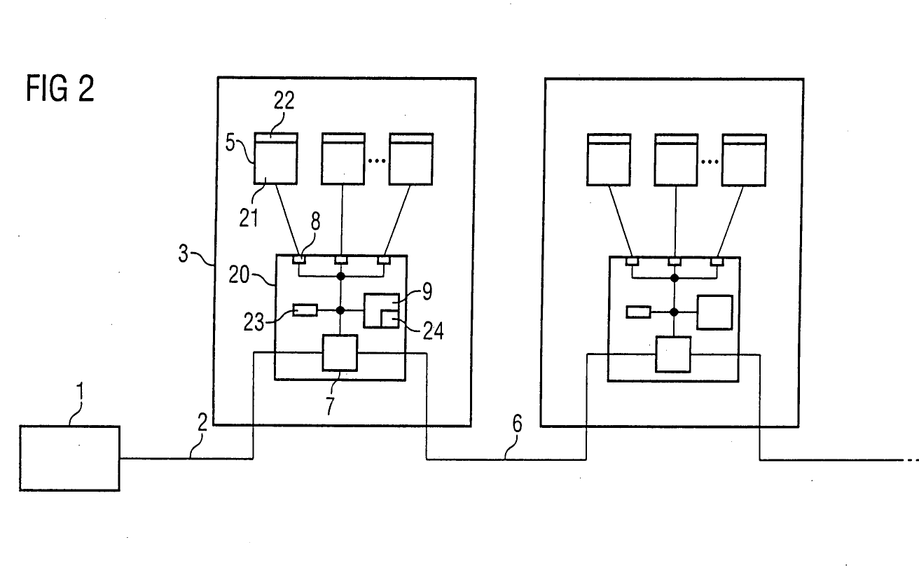

FIG. 2 shows a further embodiment of the invention. The same reference symbols correspond to the same elements with an identical function.

The memory module 3 in the second embodiment of the invention has a hub chip 20, with the address decoder unit 7 and the memory chip interfaces 8, in order to connect memory chips 5. The address decoder unit 7 divides the memory chips virtually into a first portion 21 of memory areas and into a second portion 22 of memory areas. The first portion of memory areas stores useful data, i.e. program data and other data intended to be made available to the computer system. The second portion of memory areas stores the checking data required for checking that the useful data are free of errors. The size of the first portion and of the second portion is determined by the hub chip 20. The sizes of the two portions of the memory areas may also be variably adjustable, according to requirements, depending on whether the checking data provided are intended to be simple error recognition data or error correction data.

The useful data and the checking data are made available to the error recognition unit 9 via the memory chip interfaces 8. This can be done in parallel or in serial succession (time multiplied). When useful data and checking data are read serially, idle periods can be used to transmit the checking data. The error recognition unit 9 can also comprise an error correction unit 24 which is able to repair the erroneous useful data using the checking data and to output the repaired data to the memory controller 1 via the relevant data bus.

In addition, an error register 23 is provided which can store information about one or more errors which may have occurred, such as the number of errors which have occurred, the type of errors which have occurred and/or the addresses of the errors which have occurred. This information can be retrieved from the memory module in question using an appropriate command on the address bus 2 or on a command or data bus (not shown).

The provision of an error recognition unit 9 and of an error correction unit 24 allows the memory controller 1, which usually contains the error recognition or correction unit in conventional memory systems, to be of simpler design, so that the memory controller 1 can be operated at higher data rates. Particularly when DDR-II or DDR-III memory chips are used, this can result in a significant increase in the volume of the data which are to be transmitted to and from the memory modules 3.

For server applications, it may be particularly important to track errors which have occurred, since these applications require error-free operation of the memory chips used. If errors occur, it is thus possible to replace memory modules 3 with errors early before the errors can lead to an unstable system or to erroneous execution of software.

The error recognition methods used may be error recognition methods which are already known. Thus, by way of example, the parity check method may be used, which involves checking whether a data record contains an even or uneven number of set bits. A Humming code method can be used for error correction when a single bit error has occurred in a data record.

While the foregoing is directed to embodiments of the present invention, other and further embodiments of the invention may be devised without departing from the basic scope thereof, and the scope thereof is determined by the claims that follow.

What is claimed is:

1. A hub chip for connecting one or more memory chips via a memory chip interface, comprising;
an address input for connecting the hub chip to an address bus;
an address output for connection to a further address bus;
an address decoder unit configured to utilize an address applied to the address input to selectively address one of the connected memory chips and apply the applied address to the address output; and
an error recognition unit configured to utilize provided checking data to detect an error in a memory area of the one or more memory chips.

2. The hub chip of claim 1, further comprising:
a further memory chip interface configured to receive the checking data utilized to check contents of the memory areas of the connected one or more memory chips.

3. The hub chip of claim 1, wherein at least one memory chip includes a first portion of the memory areas and a second portion of the memory areas, and wherein the address decoder unit is configured to selectively store and read useful data in the first portion of the memory areas and to selectively store and read the checking data in the second portion of the memory areas.

4. The hub chip of claim 3, wherein the error recognition unit is configured to utilize the checking data to check the contents of the memory areas of the connected memory chips.

5. The hub chip of claim 1, wherein the error recognition unit is configured to check the correct storage of the useful data using an error recognition method.

6. The hub chip of claim 5, wherein the error recognition method is a parity check method.

7. The hub chip of claim 1, wherein the error recognition unit includes an error correction unit configured to correct erroneous useful data on the basis of the checking data.

8. The hub chip of claim 7, wherein the error correction unit is configured to correct erroneous useful data on the basis of the checking data utilizing a Humming code method.

9. The hub chip of claim 1, further comprising:
an error register configured to store error information, wherein the error information is readable from the error register in the hub chip, and wherein the error information includes at least one of:
a number of errors which have occurred;
one or more types of errors which have occurred; and
the addresses of the errors which have occurred.

10. The hub chip of claim 1, wherein the checking data is provided by a further memory chip connected to the hub chip.

11. A memory module, comprising:
one or more memory chips; and
a hub chip connected to the one or more memory chips via a memory chip interface, the hub chip comprising:
an address input for connecting the hub chip to an address bus;
an address output for connection to a further address bus;
an address decoder unit configured to utilize an address applied to the address input to selectively address one of the connected memory chips and apply the applied address to the address output; and
an error recognition unit configured to utilize provided checking data to detect an error in a memory area of the one or more memory chips.

12. The memory module of claim 11, wherein the hub chip further comprises a further memory chip interface configured to receive the checking data utilized to check contents of the memory areas of the connected one or more memory chips.

13. The memory module of claim 11,
wherein at least one memory chip includes a first portion of the memory areas and a second portion of the memory areas, and wherein the address decoder unit is configured to selectively store and read useful data in the first portion of the memory areas and to selectively store and read the checking data in the second portion of the memory areas, and
wherein the error recognition unit is configured to utilize the checking data to check the contents of the memory areas of the connected memory chips.

14. The memory module of claim 11, wherein the error recognition unit is configured to check the correct storage of the useful data using an error recognition method including a parity check method.

15. The memory module of claim 11, wherein the error recognition unit includes an error correction unit configured to correct erroneous useful data on the basis of the checking data utilizing a Humming code method.

16. The memory module of claim 11, wherein the hub chip further comprises an error register configured to store error information, wherein the error information is readable from the error register in the hub chip, and wherein the error information includes at least one of:
a number of errors which have occurred;
one or more types of errors which have occurred; and
the addresses of the errors which have occurred.

17. The memory module of claim 1 1, further comprising:
a further memory chip connected to the hub chip, wherein the checking data is provided by the further memory chip.

18. A memory system, comprising:
one or more memory modules;
a memory controller; and
an address bus connecting the memory controller to a first one of the one or more memory modules;
each memory module comprising:
one or more memory chips; and
a hub chip connected to the one or more memory chips via a memory chip interface, the hub chip comprising:
an address input for connecting the hub chip to an address bus;
an address output for connection to a further address bus for connecting to subsequent memory modules;
an address decoder unit configured to utilize an address applied to the address input to selectively address one of the connected memory chips and apply the applied address to the address output; and
an error recognition unit configured to utilize provided checking data to detect an error in a memory area of the one or more memory chips.

19. The memory system of claim 18, wherein each memory chip includes a first portion of the memory areas and a second portion of the memory areas, and wherein the address decoder unit is configured to selectively store and read useful data in the first portion of the memory areas and to selectively store and read the checking data in the second portion of the memory areas, and
wherein the error recognition unit is configured to utilize the checking data to check the contents of the memory areas of the connected memory chips.

20. The memory system of claim 18, wherein the error recognition unit includes an error correction unit configured to correct erroneous useful data on the basis of the checking data; and
wherein the hub chip further comprises an error register configured to store error information, wherein the error information is readable from the error register in the hub chip, and wherein the error information includes at least one of:
a number of errors which have occurred;
one or more types of errors which have occurred; and
the addresses of the errors which have occurred.

21. The memory system of claim 18, wherein each memory module further comprises:
a further memory chip connected to the hub chip, wherein the checking data is provided by the further memory chip.
